(19) United States
(12) Patent Application Publication
(10) Pub. No.: US 2003/0056171 A1
(43) Pub. Date: Mar. 20, 2003

(54) Electronic document processing apparatus and processing method

(76) Inventors: Yutaka Yone, Tokyo-to (JP); Sanae Sakamoto, Tokyo-to (JP); Seiichi Tochihara, Tokyo-to (JP)

Correspondence Address: LADAS & PARRY, 224 SOUTH MICHIGAN AVENUE, SUITE 1200, CHICAGO, IL, 60604, US

(21) Appl. No.: 10/239,467

(22) PCT Filed: Mar. 23, 2001
(86) PCT No.: PCT/JP01/02316

(30) Foreign Application Priority Data
Mar. 24, 2000 (JP) 2000-088497
Mar. 24, 2000 (JP) 2000-088498
Dec. 27, 2000 (JP) 2000-397423
Dec. 27, 2000 (JP) 2000-397424
Feb. 15, 2001 (JP) 2001-038028
Feb. 15, 2001 (JP) 2001-038418

(51) Int. Cl. G06F 17/30

(52) U.S. Cl. 715/505

(57) ABSTRACT

An electronic document processing apparatus is connected to a user terminal and a related institution terminal via a network. Electronic forms of a plurality of documents are accumulated in a database. Each electronic form is constituted as an aggregation of constitution modules each corresponding to a part of each document. When a user designates a certain transaction, a document required for the transaction is specified, and the electronic form of the document is acquired from the database. Constitution modules constituting the electronic form are extracted based on the acquired electronic form. Each constitution module is presented to the user. When the user inputs necessary matters, constitution modules obtained after the input are combined to each other to create the electronic document of each necessary document. The created electronic document is filed to respective related institutions via the network. When necessary processes are performed by the related institutions, the log information of the processes is received by the electronic document processing apparatus, and the log information is stored to be correlated with a corresponding transaction. Therefore, log information related to the transaction is stored even after the transaction is executed to make it possible to perform a demand for reading or authentication.

### BACKGROUND OF THE INVENTION

1. Field of the Invention

The present invention relates to a technique for creating and processing an electronic document by using a network.

2. Description of Related Art

In recent years, as a part of various computerized documents and paperless documents, electronic forms of a predetermined application document, a predetermined notification document, and the like are used. For example, the electronic forms of application or notification documents filed to a public office, an electric power company, a telecommunications company, and the like with a marriage, a moving, or the like can be available via the Internet or the like. In this manner, the trouble of going to a public office and an electric power company to take necessary documents can be saved.

A user prints out electronic forms obtained as described above with a printer or the like, writes necessary items on the electronic forms, and files or submits the documents to the public office, the electric power company, and the like, respectively, by oneself or by mail.

However, the user must print out the electronic forms obtained as described above with the printer or the like, must write the necessary items on the electronic forms, and must file the documents to the public office, the electric power company, and the like by oneself or by mail eventually.

For example, in order to send address change notices to a plurality of companies or the like, an address, a name, and the like must be written on plural notification forms prepared for the those companies, respectively. It is cumbersome to prepare the documents. In addition, when a document prepared as described above has an error, it is necessary to correct the error and prepare the revised document. Therefore, it takes a lot of trouble and a long time to complete the notification to the plurality of companies or the like.

Moreover, problems related to the filed or submitted applications and the notifications may occur, and/or the user oneself may want to check the applications and the notifications. When a user holds any copies or memos of the related documents, problems do not occur. However, when the user files or submits all the necessary documents and does not have any records, the user must make inquiry to the institution to which the documents is filed, to check the filed or submitted documents. For example, when an address change notice, a job change notice, and the like are filed to a large number of institutions, the user must inquire about the documents at the respective institutions, separately. This inquiry requires a very cumbersome procedure and a long time.

Some kinds of application or notification may require a long time to perform processes in institutions to which the application or the notification is filed. When a user goes to a large number of institutions in a short period of time to file the application or the like at the time of house-moving or change of job, the user may want to grasp the degree of progress of the processes in the respective institutions.

Sometimes, memos of the user are not satisfactory depending on the purposes of the documents, and a certification or a notarization issued by a predetermined institution may be required. In addition, in case of contract with transfer of money or rights, a user may obtain a certification or a notarization for execution of a series of procedures.

### DISCLOSURE OF THE INVENTION

It is an object of the present invention to provide an electronic document processing system which enables a user to easily and rapidly prepare various notification documents or the like and to simultaneously perform check of the contents of the documents and a filing process if necessary.

It is another object of the present invention to provide an electronic document processing system which enables a user to prepare various types of application and notification documents and file the documents to related institutions via a network and then to perform reading and certification request as needed.

According to one aspect of the present invention, there is provided an electronic document processing apparatus connected to a user terminal via a network, comprising: a database in which an electronic form constituted as an aggregation of a plurality of constitution modules each corresponding to a part of one document is accumulated; an electronic form acquiring device for acquiring an electronic form required for a transaction designated by a user from the database as the aggregation of constitution modules; a presenting device for presenting the acquired constitution module to the user to request the user to input a predetermined item; and an electronic document creating device for combining the constitution modules to which the user completed information input to create an electronic document of the necessary document.

According to the similar aspect of the present invention, there is provided an electronic document processing method executed in an electronic document processing apparatus which is connected to an user terminal via a network and which has a database in which electronic forms constituted by are accumulated as an aggregation of a plurality of configuration modules respectively corresponding to parts of one document, including: the process of acquiring an electronic form of a document required for a transaction designated by the user from the database as the aggregation of constitution modules; the process of showing the acquired constitution module to the user to request the user to input a predetermined item; and the process of combining constitution modules to which the user completed information input to form an electronic document of the required document.

According to the electronic document processing apparatus or method constituted as described above, the electronic forms of a plurality of documents are accumulated in the database. Each electronic form is constituted as an aggregation of constitution modules each corresponding to one part of a document. When a user designates a transaction, a document required for the transaction is specified, constitution modules constituting the electronic form of the document are acquired from the database, and the respective constitution modules are presented to the user. When the user inputs necessary information, electronic documents of necessary documents are created by combining the input constitution modules. Therefore, the user can easily and rapidly creates a plurality of necessary electronic documents by her/his own terminal device.

The presenting device may show a constitution module which is commonly included in a plurality of electronic forms only once. Therefore, the user does not have to repeatedly input items common in a plurality of documents.

The electronic document processing apparatus may further includes a correction request device for receiving a constitution module to which the user completed information input, checking an input item depending on a predetermined check process method, and, if the input item has an error, showing that the input matter has an error to the user to request the user to correct the error. Therefore, an input error is corrected in advance, and a complete document can be created.

The electronic document processing apparatus may further include a document filing device for transmitting a created document to a destination terminal device via the network; and a report device for receiving a notification of completion of filing the document from the destination terminal device and making a report of completion of filing to the user. Therefore, the created document is transmitted to a filing destination, and a user can check the completion of the filing.

The electronic document processing apparatus may further include a time information recording device for recording information of a time when the document filing device transmits a document to a destination terminal and recording information of a time when the user receives the notification of completion of filing from the destination terminal device. Therefore, even after the process is completed, a user can obtains information related to time at which the process is executed.

The report device may report the time information recorded by the recording device such that the time information is included in the report of completion of filing. Therefore, a user can know the completion time of the process.

Each of the constitution modules may include check information, and the correction request device may make a correction request with reference to the check information. Therefore, a checking method or the like can be controlled for each constitution module.

The check information may represent the type of a constitution module including the check information therein and the degree of importance of an item input to the constitution module, and the correction request device may check whether a correction request is made depending on the degree of importance and may determine the degree of correction request. Therefore, an appropriate checking method can be employed in consideration of the degrees of importance of the constitution modules.

The electronic document processing apparatus may further include a constitution module creating device for acquiring a constitution module designated by the database depending on an operation of an operator and changing the constitution module to create a new constitution module. Therefore, a new constitution module is created by correcting and combining the existing constitution modules, and thus the library of the constitution modules can be enhanced.

The constitution module may include display specifying information for specifying display information related to the constitution module, and the presenting device may present the constitution module and the display information related to the constitution module to the user with reference to the display specifying information. Therefore, an advertisement, a guidance, a message and the like related to a constitution module displayed at the present can be shown to a user.

The electronic document processing apparatus may further include an automatic input/output device for acquiring information to be input to the constitution module presented by the presenting device from an external storage medium designated by a user to automatically input/output the information to the constitution module. Therefore, general personal information such as the address, the name and the like of a user can be automatically input and output without manually inputting and outputting the general personal information with the user. The user can save the trouble.

According to another aspect of the present invention, there is provided an electronic document processing apparatus connected to a user terminal and a related institution terminal via a network, including: a constitution module acquiring device for acquiring a constitution module constituting an electronic form of a document required for a transaction designated by a user; an electronic document creating device for transmitting the constitution module to the user via the network and receiving a constitution module subjected to a creating process by the user to create an electronic document as an aggregation of constitution modules; a module log recording device for recording and storing a module log serving as log information of processes performed by the user and the electronic document creating device in creation of an electronic document by transmission/reception of the constitution module with the user.

According to the similar aspect of the present invention, there is provided an electronic document processing method executed by an electronic document processing apparatus connected to a user terminal and a related institution terminal via a network, including: the process of acquiring an electronic form of a document required for a transaction designated by the user; the process of transmitting the constitution module to the user via the network and receiving the constitution module subjected to a creating process by the user so as to create the electronic document as an aggregation of constitution modules; and the process of recording and storing log information of processes performed by the user and the electronic document processing apparatus in creation of an electronic document by transmission/reception of the constitution modules between the user and the electronic document processing apparatus.

According to the electronic document processing apparatus or method constituted as described above, when the user designates a desired transaction, constitution modules constituting the electronic form of the document required for the transaction. The user receives the constitution modules, inputs necessary items, and returns the document to the electronic document processing apparatus. In this manner, the constitution modules are transmitted/received between the electronic document processing apparatus and the user, so that an electronic document to be filed to a related institution is created. Log information of processes performed by the user and the electronic document processing apparatus in the creation of the electronic document by the transmission/reception of the constitution modules between the user and the electronic document processing apparatus is recorded and stored in units of constitution modules. Therefore, even after the transaction is executed, the log information can be stored in small units, i.e., units of constitution modules.

The module recording device may record and store the log information as attribute data of constitution modules in units of constitution modules. Therefore, the log information in units of constitution modules is recorded as a part of the constitution module.

The module log recording device may record log information at fineness levels on the basis of at least one of the type or the degree of importance of a constitution module, contents input to the constitution module and a combination of a plurality of constitution modules. Therefore, log information can be recorded at an appropriate level depending on the type or the degree of importance of a constitution module.

The electronic form creating device may append a necessary electronic signature to each constitution module and request a user to append the necessary electronic signature to each constitution module. Therefore, reading, verification and the like of the processes performed for the respective constitution modules.

The electronic document creating device may determine the necessity of a request of an electronic signature to a user and a type of the electronic signature to be requested on the basis of at least one of the type or the degree of importance of a constitution module, contents input to the constitution module and a combination of a plurality of constitution modules. Therefore, an appropriate digital signature is performed depending on the contents, the degrees of importance of the constitution modules.

The electronic form processing apparatus may further include: a transmission device for transmitting an electronic document created by the electronic document creating device to a related institution terminal via the network; and a transaction recording device for receiving log information of processes performed in the related institution and recording the log information as a transaction log such that the log information is correlated with the transaction. Therefore, log information is recorded and managed at two levels of a transaction unit and a constitution module unit.

The electronic document processing apparatus may further include: a reception device for receiving a demand for reading the log information from the user; and a log information providing device for acquiring a transaction log corresponding to a transaction designated by the demand for reading to provide the transaction log to the user. Therefore, after a transaction is completed, processes performed in relation to the transaction can be checked.

The log information providing device may acquire the module log when the demand for reading includes designation of a constitution module, and provide the module log to the user. Therefore, when a constitution module is designated, the log information related to the constitution module can be read.

The electronic document processing apparatus may further include: a reception device for receiving a demand for verifying the log information from the user; a verification device for acquiring a designated transaction log or a log information corresponding to the constitution module when the demand for verification is received, and performing verification related to the acquired log information. Therefore, verification can be performed in units of all the transactions and the constitution modules.

The electronic document processing apparatus may further include a degree-of-progress notification device for referring to a transaction log corresponding to a designated transaction and a module log related to the transaction when a degree of progress is inquired by the user, acquiring the degree of progress of the transaction, and notifying the user of the degree of progress. Therefore, when a user interrupts a transaction, a present progress can be accurately known.

The electronic document processing apparatus may further include a log output device for outputting the log information to a recording medium of the user. Therefore, log information can be recorded on a recording medium of the user.

### BRIEF DESCRIPTION OF DRAWINGS

FIG. 1 is a block diagram showing the schematic configuration of an electronic document processing system according to the first embodiment of the present invention.

FIG. 2 schematically shows the configuration of an electronic form according to the present invention.

FIGS. 3A to 3E show concrete examples of constitution modules.

FIG. 4 is a flow chart showing an electronic document process according to the present invention.

FIG. 5 shows display examples of messages displayed on terminal devices at respective positions during the electronic document process shown in FIG. 4.

FIG. 6 shows display examples of messages displayed on terminal devices at respective positions during the electronic document process shown in FIG. 4.

FIGS. 7A to 7C show examples of documents made by the electronic document process shown in FIG. 4.

FIG. 8 shows an example of prepared application document.

FIG. 9 shows a workflow of an electronic document processing system according to the second embodiment of the present invention.

FIGS. 10A and 10B conceptually show the configurations of transaction files.

FIG. 11 conceptually shows the configuration of an electronic form in the second embodiment.

FIG. 12 shows an example of module attribute information included in a configuration module.

FIG. 13 is a flow chart showing an electronic document process according to the second embodiment of the present invention.

### DETAILED DESCRIPTION OF THE PREFERRED EMBODIMENTS

Preferred embodiments of the present invention will be described below with reference to the accompanying drawings.

(First Embodiment)

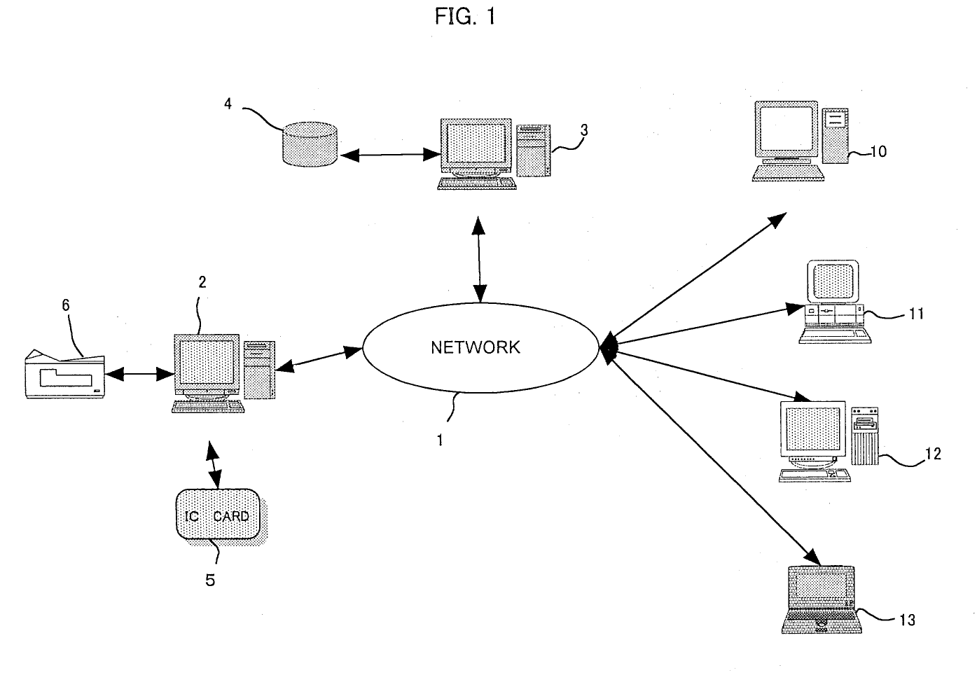

FIG. 1 shows the schematic configuration of an electronic document processing system according to the first embodiment of the present invention. As shown in FIG. 1, the electronic document processing system includes a client terminal 2, an A-company server 3 and a plurality of terminals 10 to 13 of related companies are connected to each other via a network 1. A most preferable example of the network 1 is the Internet. The client terminal 2 is used by a user who performs a predetermined notification, a predetermined application, and the like, and can be installed in the home or in the workplace of the user. The client terminal 2 has an IC card reader, and can input and output various data to or from an IC card 5 (to be described later). A printer 6 is connected to the client terminal 2, and can print out an electronic form (to be described later).

The related-company terminals 10 to 13 are business organizations to which a user performs notification and application processes. In the following example, the plurality of related-company terminals 10 to 13 includes a B-bank terminal 10, a C-bank terminal 11, a D-credit-company terminal 12 and an E-mobile-company terminal 13.

The company A is a company which supports notification and application procedures of users, and provides the electronic forms of necessary notification and application documents to the users as a most basic service. Company A also checks the contents of a prepared document on which a user writes necessary items if the user requests, files the prepared document to related companies instead of the user, and confirms that the respective companies complete their necessary procedures to report the completion of the procedures to the user.

In addition, the company A, at user's request, records and stores the log of the procedures depending on the type, the degree of importance, and the like of an application document as will be described later to enable the user to read the log later. At user's request, the company A performs certification, notarization, and the like of the completion of a series of procedures.

The A-company server 3 is connected to the database 4. The database 4 includes a form library in which the electronic forms of various notification and application documents are stored. The present invention has such a characteristic feature that the electronic forms of the various notifications, applications, and the like accumulated in the form library are constituted as an aggregation of constitution modules.

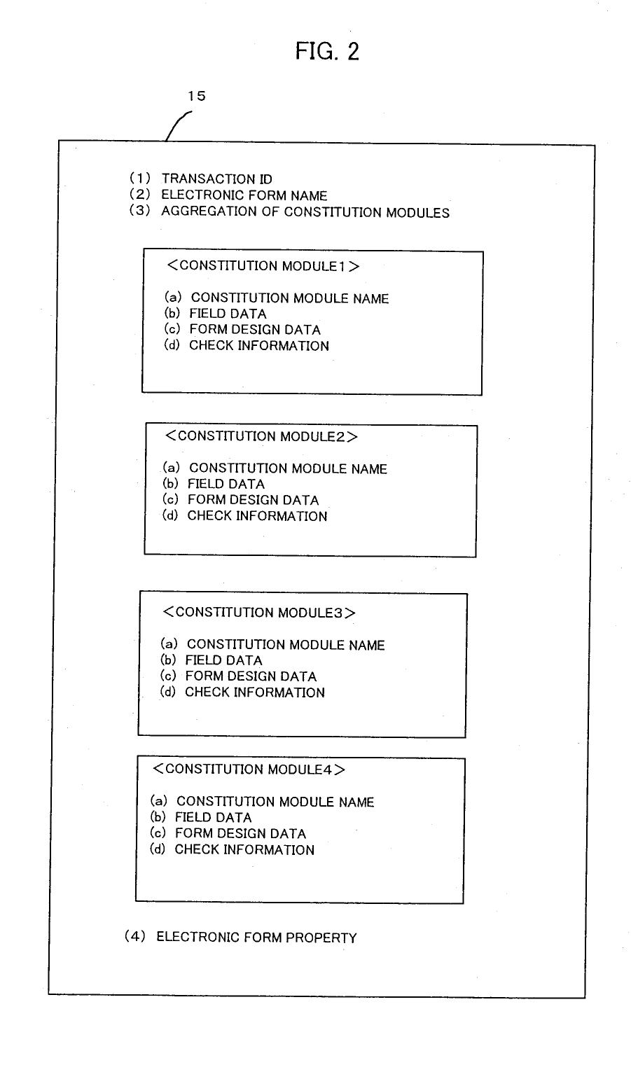

FIG. 2 schematically shows the configuration of electronic form data accumulated in the form library. An electronic form 15 includes four data, i.e., a transaction ID, an electronic form name, an aggregation of constitution modules, and an electronic form property.

The “transaction ID” is an ID of a series of processes, i.e., a procedure (transaction) performed by the company A on behalf of the user. In an example to be described later, a user performs a request for suspension of service by a series of processes to related companies because the user loses her/his bag. This series of processes are considered as one transaction, and a transaction ID is given to the transaction. Therefore, when the user requests the company-A to execute the request for the suspension of service to the related companies, one transaction ID is given to the whole transaction. For this reason, a common transaction ID is given to a plurality of electronic forms used in one transaction. In addition, the transaction ID is also used when the user make an inquiry after the completion of the processes.

The “electronic form name” is a title of each electronic form. For example, as the title, “request for suspension of service to bank B”, “request for suspension of service to mobile phone company E”, and the like are used.

The “constitution module” is a constituent element of the electronic form 15, and can be conceptually considered as one of a plurality of parts obtained by dividing one document data. For example, a notification for changing a deduction bank account to a certain credit company has an input section of address/name, an input section of credit card number, an input section of changed account and the like. In the present invention, each input section is constituted as a constitute module. As an aggregation of these constitution modules, one notification for changing a deduction bank account is made.

As shown in FIG. 2, each constitution module includes a constitution module name, field data, form design data, check information, and the like. The “constitution module name” is the title of the constitution module. As the example of the “constitution module name”, “input section of address/name”, “input section of changed account” or the like are used. The “field data” is data of respective items constituting the constitution module, and the “form design data” is display data for a rule, a frame, a hatched area, an item name, and the like which are used when these items are displayed on a display. The “check information” is related information required when input matters to the items input by the user are checked.

The “electronic form property” is a field to store information of a route in which the electronic form flows during the workflow of a series of transactions, and is mainly used by the A-company server 3. In this field, a log of respective processes performed to the electronic form during the workflow is also recorded. This is also used during a verification process of the transaction (to be described later). The IDs and the like of other electronic forms flowing in the same transaction are also recorded.

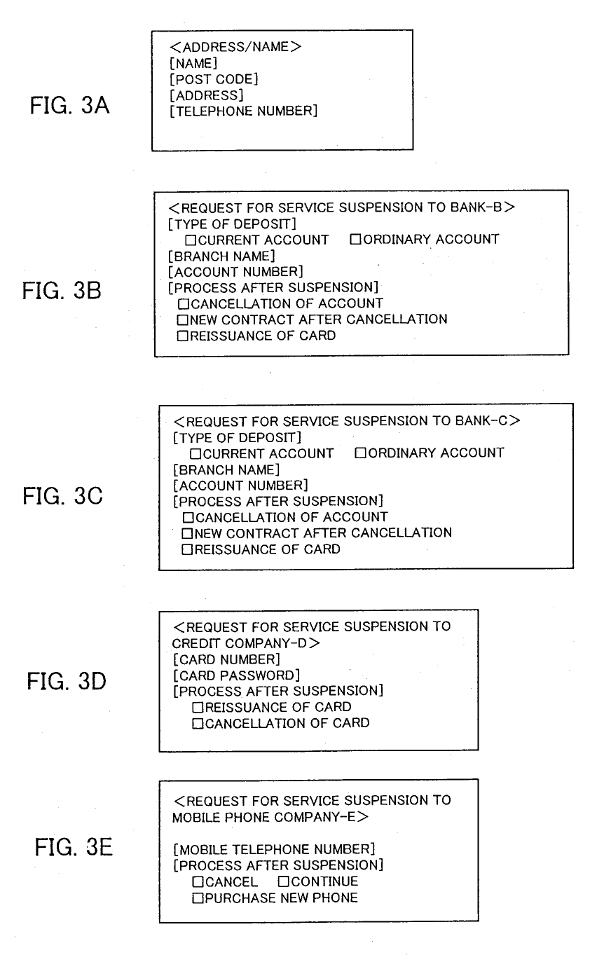

The specific examples of the constitution modules are shown in FIGS. 3A and 3E. FIG. 3A shows the constitution module of “Address/name”, and FIGS. 3B and 3C show the constitution modules of “Request for suspension of service to bank B” and “Request for suspension of service to bank C”. FIG. 3D shows the constitution module of “Request for suspension of service to credit company D”, and FIG. 3E shows the constitution module of “Request for suspension of service to mobile phone company E”. When a user files the requests for suspension of service to bank B, bank C, credit company D, and mobile phone company E, respectively, an input section of “Address/name” is common for all documents. Therefore, the constitution module of “Address/name” is commonly used in the electronic forms, so that the user can save the trouble of inputting the address and the name to the all documents separately. More specifically, the electronic form of a request for suspension of service to bank B is constituted as an aggregation of the constitution module of “Address/name” and the constitution module of “Request for suspension of service to bank B”. Similarly, the electronic form of a request for suspension of service to bank C can be constituted by an aggregation of the constitution module of “Address/name” and the constitution module of “Request for suspension of service to bank C”. In this manner, items such as an address and a name which are common in many documents are constituted as one constitution module, and the constitution module is used in the electronic forms of a plurality of documents in common. By this, a user does not have to repetitively input the same matter for many times.

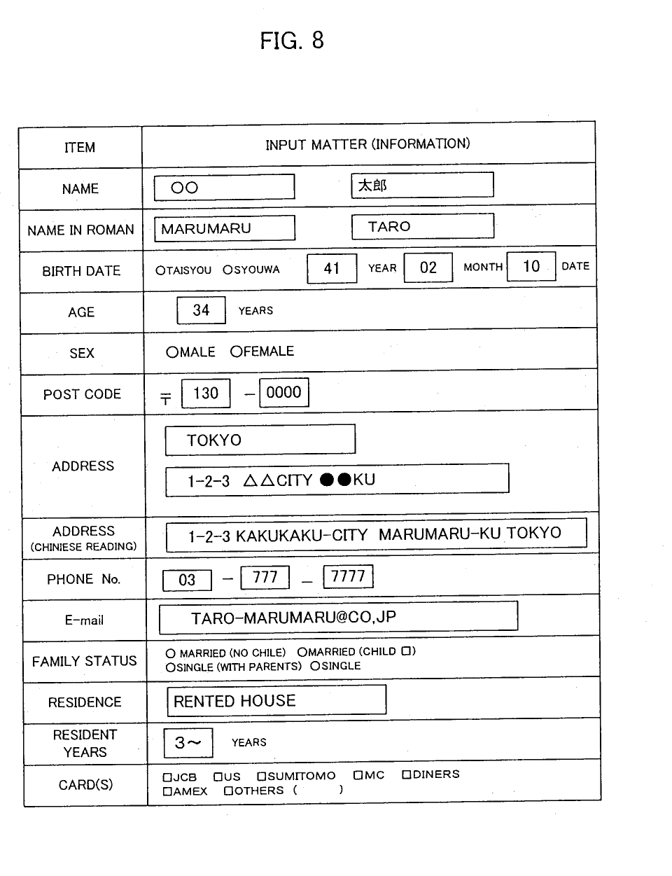

An example of the electronic form constituted by a combination of a plurality of constitution modules is shown in FIG. 8. In the example in FIG. 8, for example, the items “Name” and “Name in Roman alphabet” can be defined as one constitution module, and the items “Birth date”, “Age”, and “Sex” can be defined as one constitution module. The items “Post code”, “Address”, “telephone number” and “E-mail address” can be defined as one constitution module, and the items “Family structure”, “Residence status” and “Years of residence” can be defined as one constitution module. Therefore, the example of the electronic form shown in FIG. 8 can be created as an aggregation of the plurality of constitution modules.

Some constitution modules are mainly constituted by character strings as shown in FIGS. 3A to 3E, and the other constitution modules are constituted as modules including predetermined tables (hereinafter referred to as “table modules” ). For example, in a tax final return document to be filed to a tax office, in addition to the input sections of the address, the name and the like of a declarer, table areas to input amounts (numerical values) of incomes and necessary expenses are made. These table areas are constituted as a table module, and the plurality of table modules are combined to each other to constitute the electronic form of the tax final return document. Furthermore, an automatic calculation function can be added to the table module itself. For example, an automatic calculation function which automatically sums up the amounts in the predetermined items in the table module and input the total amount to a blank for a total amount can be added to each table module.

The examples of the constitution module having the automatic calculation function are as follows. When the transaction is an insurance contract, an insurance fee calculation module can be included in the electronic form of an insurance application. When the transaction is a loan contract, a loan estimation module can be included in the electronic form of a loan application. When the transaction is to prepare or file a personal history, the electronic form of the personal history may include a personal history producing module which automatically calculates years of graduation from schools when a birth data is input. In addition, as a module having a function for decision, evaluation or the like except for a simple automatic calculation function may be included in an electronic form. For example, an aptitude test module which diagnoses an appropriate type of occupation of a person on the basis of an academic career, a business career and other conditions can be included in the electronic form of the personal history. It is noted that the modules (function modules) having the calculation, decision or evaluation functions are constituted as software and added to the electronic form data. When a user inputs necessary matters to the electronic form, the modules are executed.

As described above, the constitution modules are accumulated in the database 4 connected to the A-company server 3. However, in the A-company server 3, an operator may change or correct a constitution module existing in the database 4 as needed, and may combine a plurality of constitution modules to each other to produce new constitution modules. The new constitution module produced as described above is provided to a user and accumulated in the database 4. In this manner, necessary constitution modules are gradually accumulated in the database 4. In addition, if necessary, the name of the producer, the name of a company related to the production, an electronic signature and the like can be added to the new constitution modules produced as described above, so that the constitution modules can be managed.

One characteristic feature of the present invention is that the respective modules have check functions. The check function is a function to decide whether matters input by a user to the constitution module are appropriate or not from various viewpoints. If the input matter is not appropriate, the function notifies the user that the input matter is not appropriate and requests the user to input again. For example, in the “Address/name” module”, when a post code or a telephone number does not correspond to the address input by the user, the function can notify the user that the post code or the telephone number does not correspond to the address, and can request the user to correct the post code or the telephone number. In the case of the table module described above, if the amounts input by a user do not coincide to each other (for example, a total amount is not correct), the function can notify the user that the amounts do not coincide. In addition, such an error that a plurality of items are designated (checked) as an alternatively input item such as an item “Type of deposit in the “Request for suspension of service to B-bank” module can be detected. When a certain constitution module includes a mandatory input item which is necessary in execution of the transaction and a referential input item (unnecessary), the function can notify a user that the mandatory input item is not input.

Furthermore, the level of the check can be changed on the basis of a type of module or the matters input to the module by the user. For example, a plurality of modules may be classified depending on the degrees of importance of the modules such that the level of the check for a module having a high degree of importance is raised and/or a module having a low degree of importance is not checked. A module including a very important item in the transaction can be always automatically checked by the A-company server even if the user does not desire. It can be determined depending on the matter input by a user whether a check is performed or not, or the level of the check can be determined by the input matter. For example, in a contract with transfer of money, when an amount is higher than a predetermined amount, it can be designed that a check having a considerably high level is performed. Information related to the check function is included in check information of each constitution module (see FIG. 2).

With the above check function, a user can make an appropriate document. Since the check function can be executed for each module, the user cannot advance to the next step without correctly creating one module, and processes can be efficiently performed. The check function, as will be described later, can be designed to be performed only when it is confirmed by the user whether the check function is desired or not and when the check function is desired.

A user can read necessary information from the IC card 5 by using the IC card reader arranged in the client terminal 2, and can writes the information in the IC card 5. For example, log data related to a certain transaction (to be described as follows) and matters input to a constitution module by a user can be recorded on the IC card 5. In this manner, if the log data or the items will be required later, the user can confirm the details of the transaction performed by herself/himself. Data related to a transaction performed in the last house-moving by a user who frequently moves due to nature of job may be recorded on the IC card 5, and the previously input data of an unchanged item in this moving may be used to make the user to input only necessary matters (address or the like of a new address), so that the procedure can be easily completed.

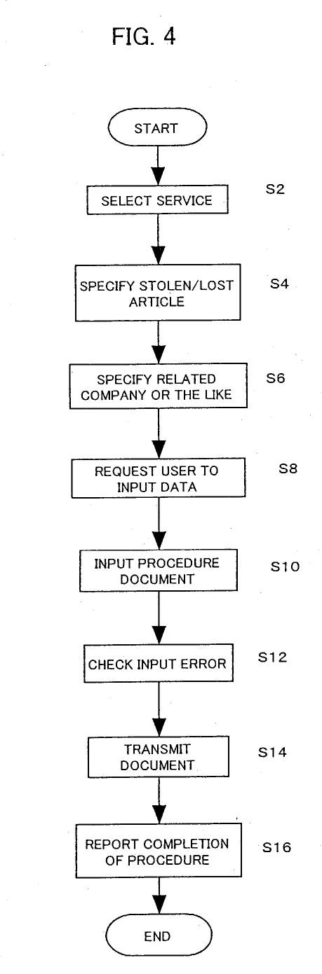

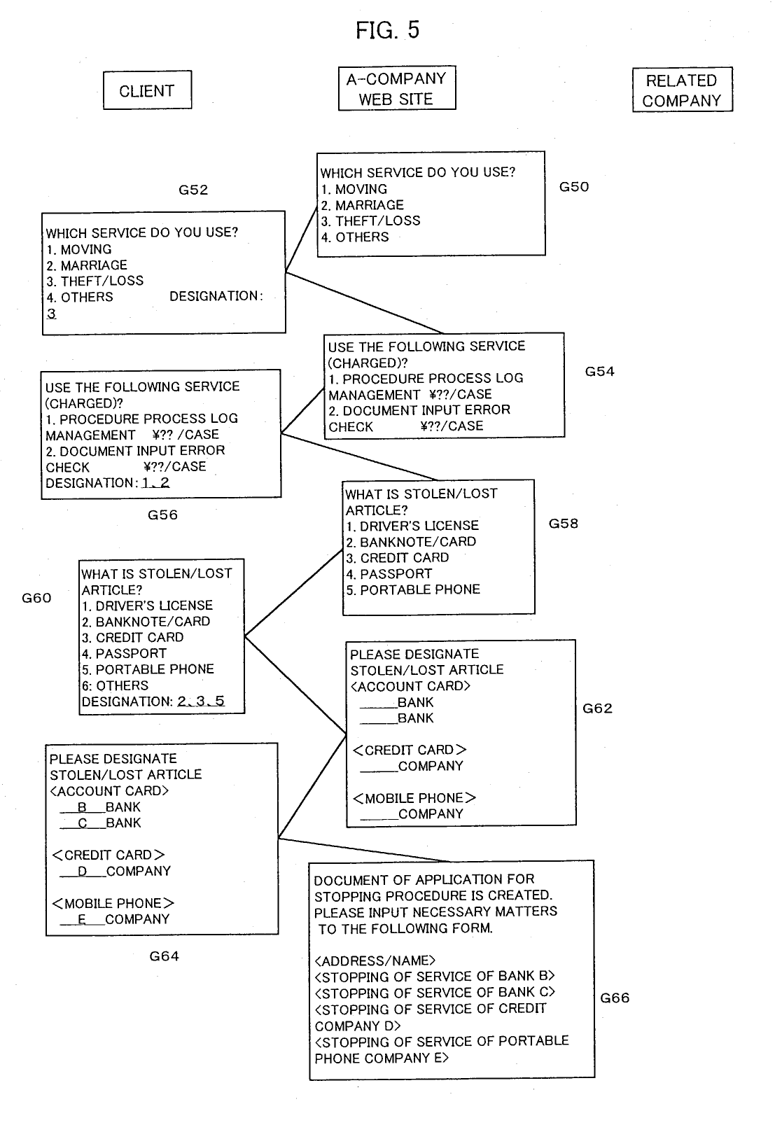

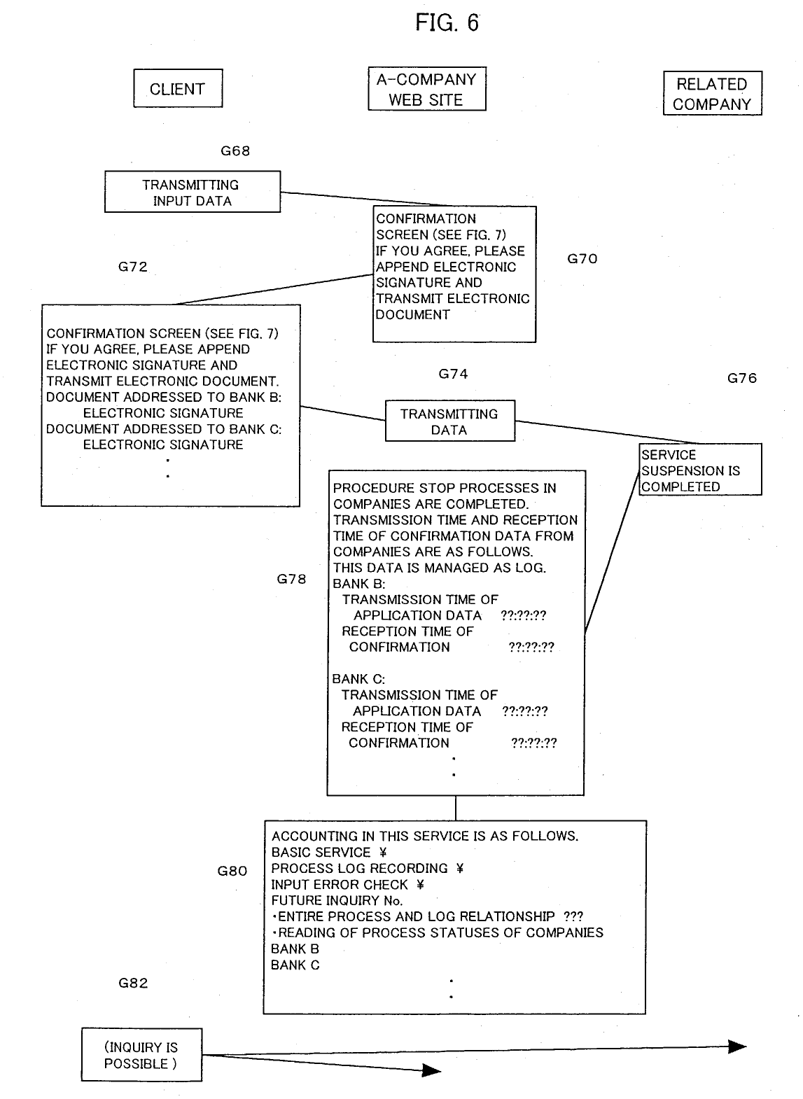

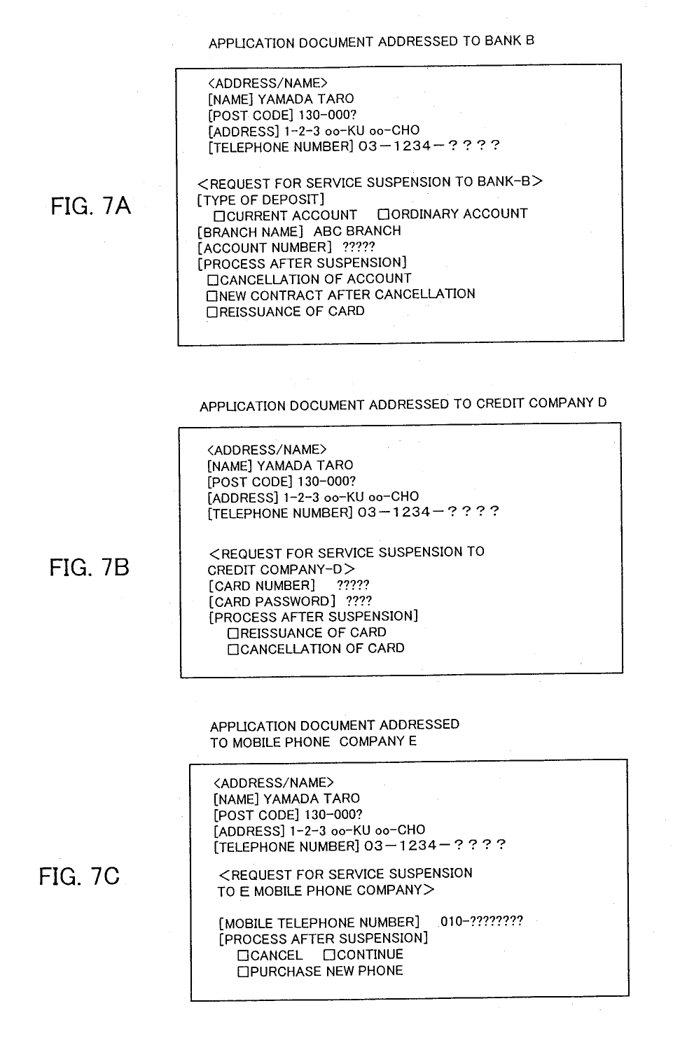

Next, an operation of the electronic document processing system according to the present invention will be described below with reference to FIG. 4 to FIGS. 7A to 7C. FIG. 4 is a flow chart showing an electronic document process according to the present invention, and FIGS. 5 and 6 show message screens displayed on the client terminal 2 in the electronic document process shown in FIG. 4. FIGS. 7A to 7C show examples of documents created by the electronic document process shown in FIG. 4. In the following example, the following case will be exemplified. That is, a user P lost her/his bag and performs a request for suspension of services with the loss of the card of a bank account, a credit card and the like in the bag. More specifically, it is assumed that the user P loses the cards of accounts of bank B and bank C, a credit card of credit company D, and a mobile phone of mobile phone company E.

Referring to FIGS. 4 and 5, the user P who lost her/his bag operates her/his client terminal 2 to access a web site managed by the A-company server 3 so that a service screen (screen G50) is displayed. As shown in a screen G52, the user P selects a desired service (in this case, “3. THEFT/LOSS”) With this selection, one transaction which is a theft/loss process is determined to set a transaction ID, and a series of processes are executed.

When the user P designates the desired service, as shown in a screen G54, the guidance of an ancillary service provided by company A is displayed. As shown in a screen G56, it is assumed that the user P selects both the services of “procedure process log management” and “document input error check”. The “procedure process log management” is a service which records a log of respective processes in this transaction. When the user P receives this service, if any problem occurs later, the user P can receive confirmation and verification of the completion of the procedure. On the other hand, the “document input error check” is, as will be described later, a service which causes company A to check whether matters input in an electronic form by the user P include an error or not.

Then, as shown in a screen G58, a screen for designating a stolen/lost article appears, and the user P designates a lost article (step S4). In this example, as shown in a screen G60, the user P designates a “banknote/card”, a “credit card”, and a “mobile phone”. Then, as shown in a screen G62, a screen for designating a stolen/lost article appears. As shown in a screen G64, the user P designates a related company of each stolen/lost article (step S6).

Upon completion of the designation of the related companies of the stolen/lost articles, the process goes to the preparation of notification documents to be filed to each related company. The A-company server 3 accesses the form library in the database 4 to acquire electronic form data of the specified notification documents. Constitution modules included in the electronic form data of the plurality of acquired documents are extracted, and the constitution modules are displayed as shown in a screen G66 one by one to make the user P input data (step S8). In the screen G66, for illustrative convenience, only the module names of the constitution modules are displayed. However, in fact, as shown in FIG. 3, the contents of the constitution modules are displayed. The user P inputs necessary matters into the blanks of respective constitution modules (step S10). Upon completion of the input, the user P transmits the written data to the A-company server 3 (screen G68).

The A-company server 3 receives the data input by the user P and checks the input error (step S12). This operation is performed by executing the check function with reference to the check information described above. Thus, the user P can prevent a document including error or fault from being filed to the relative companies.

Upon completion of the check of input errors, the A-company server 3 displays a confirmation screen as shown in a screen G70 to urge the user to check the confirmation screen. For illustrative convenience, the details of the confirmation screen are shown in FIGS. 7A to 7C. As is apparent from these drawings, the electronic documents of the notification documents are constituted as aggregations of a plurality of modules. The user P performs confirmation, appends electronic signatures to the electronic documents, and transmits the electronic documents to the A-company server 3 (screen G72). The A-company server 3 transmits the electronic documents to which the electronic signatures (i.e., encoded) of the user are appended to the respective related companies (step S14, screen G74). Any encoding method may be used for the electronic signatures.

Each related company receives an electronic application document, executes a procedure to suspend the service, and reports the completion of the procedure to suspend the service to the A-company server 3 (screen G76). The A-company server 3 manages the dates and times at which the application documents are filed to the respective related companies, the dates and times at which confirmations of procedure are received from the related companies, and the like as log management. The A-company server 3 reports the completion of the procedures to the user P with those date ant time data (step S16, screen G78). The user P watches the screen G78 to know that the procedures are completed without any trouble. In addition, the A-company server 3 presents accounting information related to the services which have been performed to the user P (screen G80). In this case, inquiry numbers corresponding to the respective processes are displayed on the screen G80. The user P can inquire about the process by using the inquiry number hereafter (screen G82). This inquiry information may the transaction ID. In this manner, the transaction of a theft/loss notification of the user P is completed.

In the embodiment described above, when company A supplies the electronic forms to a user in response to the request by the user, the user designates a desired service or the like by using an input device on a client terminal, and the electronic form corresponding to the designated service is transmitted to the client terminal. However, as another method, for example, an electronic form can be designated by using real media such as magazines, newspapers, and books. For example, on an article of a magazine or the like, an ID for specifying an electronic form related to the article is printed. A user accesses the A-company server 3 and inputs the ID, so that the corresponding electronic form can be designated. Furthermore, a bar code or the like is printed on a magazine or the like in place of an ID, and a user reads the bar code by using a bar code reader attached to a client terminal, so that the corresponding electronic form can be designated. When an electronic book or electronic paper except for a magazine or the like is used, an ID, a bar code, or the like for specifying an electronic form can also be displayed. Still further, when a mobile phone or a PDA is used in place of the client terminal, an ID can be input, or a bar code can be read by connecting a bar code reader to such a device and the data can be transmitted. In this manner, a user can easily acquire an electronic form by using a magazine and a mobile phone at a place outside the home or workplace.

In the above example, all the notification procedure are executed on the network. However, some document requires sealing of a specific seal. When an electronic signature cannot be substituted for the sealing, the user prints out notification documents by the printer 6 attached to the client terminal 2, and the user seals these application documents to file the documents to predetermined institutions. Meanwhile, the processes are temporarily separated from the network. Thereafter, the institution which receives the document performs a necessary examination or the like, decides the suspension of the service, and reports the decision of the suspension of the service to the user via the network. This operation corresponds to a case in which the processes in the screens G70 to G76 in FIG. 6 are performed without the network.

Upon completion of the transaction, the user may receive log data related to the transaction from the A-company server 3 and records the log data on the IC card 5, so that the user can keep the log data by herself/himself.

In the example described above, the user inputs necessary information to the respective constitution modules. However, when the information of the user is stored in a personal information database connected to the network, the user can access the personal information database by using an ID or the like which authenticates the user herself/himself, and stored information can be automatically input to the constitution modules. This operation can similarly performed when personal information is stored in the above-mentioned IC card or another storage medium.

As another application, as shown in FIG. 5, in the step of inputting a necessary information to a constitution module by a user, the web site of A-company can display a message or advertisement information related to the constitution module on a screen. For example, when constitution modules constituting a request for suspension of service is given to the user who lost a cash card, the information of a theft insurance of the cash card can be displayed together with the constitution modules. Similarly, the information of a mobile phone of a new type can be displayed for a user who makes a request for suspension of the service in the loss of her/his mobile phone. In addition, when a certain constitution module is shown to a user, depending on the progress of the transaction, for example, information of a degree of progress of all the processes at this time can also be notified to the user.

Information for specifying data or websites of the advertisement information and the message are stored as attribute information or the like in each constitution module in advance. When the constitution module is read from the database 4, the A-company server 3 may automatically access the data or the website to display advertisement information.

The application contents and the related companies described above are only examples. The present invention can be applied to a case in which documents are filed to various related companies, public offices, people and the like in various situations such as a moving and a marriage. In addition, the constitution modules shown in FIGS. 3 and 7 are only examples. For example, the constitution modules can also be constituted in smaller units such as addresses, names, and telephone numbers.

As described above, according to the electronic document processing system of the present invention, a user communicates with a service provider via a network to easily acquire the form of a document required for a notification or an application desired by the user, and the user can rapidly file the document to related institutions immediately. Therefore, a plurality of necessary procedures can be rapidly performed at once.

Since the electronic form of a notification, an application or the like is constituted as an aggregation of a plurality of constitution modules, one module can be commonly used in various documents. Therefore, a user does not have to repeatedly input common information to a plurality of documents. In addition, when a user requests the electronic document processing system to check input matters, the written matters can be checked before the documents are filed to the related institutions. Thus, a procedure error can be prevented, and time required for the processes can be shortened.

When a checking method or the like is set for each constitution module, the check function can be improved in accordance with the types of the respective constitution modules, input contents, and the like.

(Second Embodiment)

The second embodiment of the present invention will be described below. Since the configuration of the electronic document processing system according to the second embodiment is the same as the configuration according to the first embodiment shown in FIG. 1, a description thereof will be omitted. The same drawing is referred to in the description of the same process as that of the first embodiment.

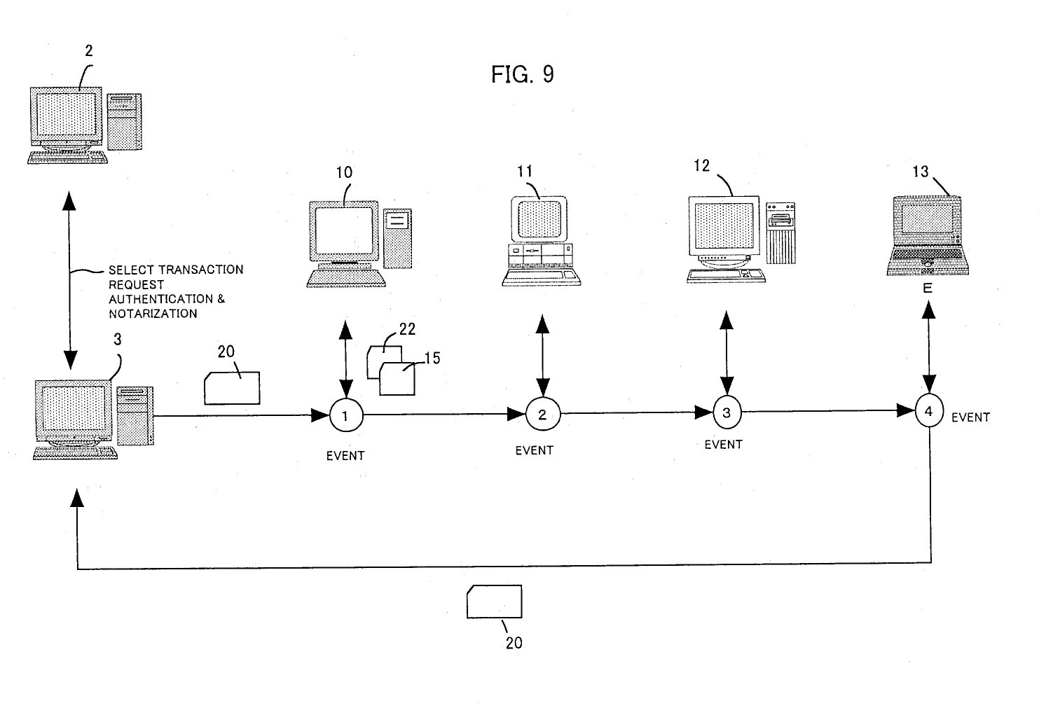

FIG. 9 shows a workflow of the electronic document processing system according to the second embodiment of the present invention. When a user accesses an A-company server 3 via the Internet 1 and requests the A-company server 3 to perform one process/procedure (to be referred to as a “transaction” hereinafter), the A-company server 3 creates a predetermined electronic document with a client terminal 2 operated by the user. The created electronic document is filed to related companies 10 to 13 to execute the process/procedure. When the A-company server and the related companies perform predetermined processes, logs including information such as reception times of the electronic documents and completion times of the processes are recorded, and stored in the A-company server.

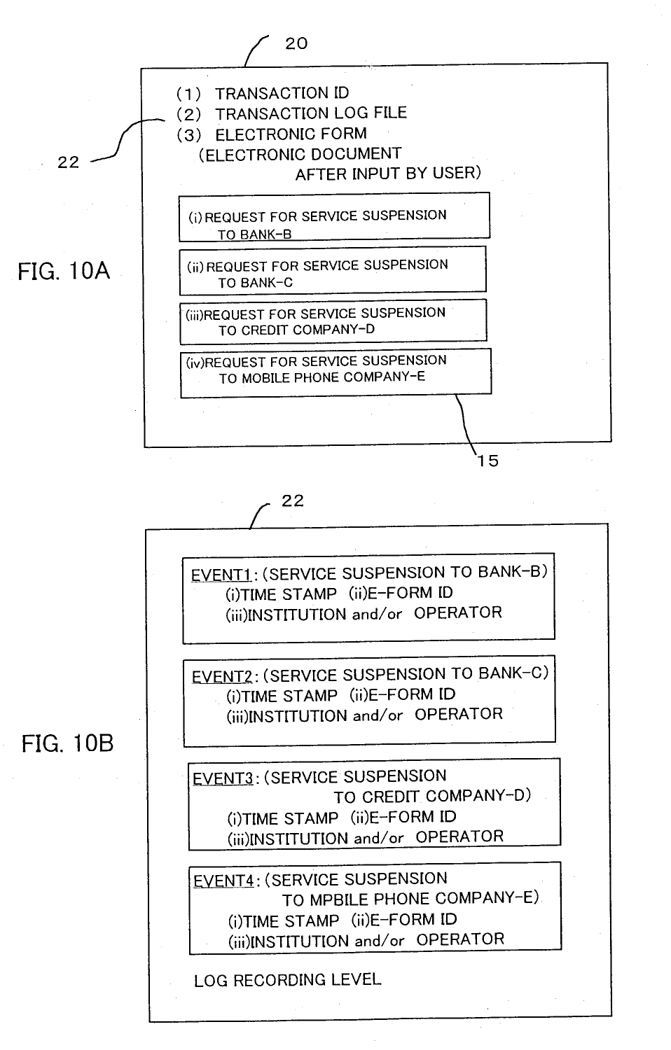

FIG. 10A conceptually shows the configuration of a transaction file used in the electronic document processing system according to the present invention. When a user requests the A-company server 3 to perform one transaction, one transaction file is created. For example, it is supposed that a user loses her/his bag and bankcards of bank B and bank C, a credit card of credit card company D and a mobile phone of mobile phone company E which are put in the bag, and the user performs request for suspension of service. It is assumed that the procedure of request for suspension of the service for a plurality of related companies is performed by one transaction. Each process/procedure or the like executed in the transaction is also called an “event” (see FIG. 9). In this embodiment, each process of filing a request for suspension of service to each related company is defined as an event.

As shown in FIG. 10A, a transaction file 20 includes a transaction ID, a transaction log file and an electronic form. The transaction ID is identification information given to each transaction. A transaction log file 22 is a file in which a log of processes performed in the transaction is stored. An electronic form 15 is an electronic form of a document to be filed to related companies. In this embodiment, as the electronic form 15, the forms of request for suspension of service to bank B, bank C, credit company D and mobile telephone company E are included. In this specification, data before necessary matters are written by a user is called an “electronic form”, and data obtained after necessary matters are written by the user is called an “electronic document”.

FIG. 10B conceptually shows the configuration of the transaction log file 22. The transaction log file 22 is formed every event. In this embodiment, four transaction log files are formed. Each transaction log file 22 includes a time stamp (time recording information) of a process performed in the event, the ID of an electronic form used in the event and information of an institution and/or an operator which performs the process. The institution which performs the process in each event describes the information in the transaction log file 22 corresponding to the event. The transaction log file includes a log recording level of a transaction log. The log recording level will be described below.

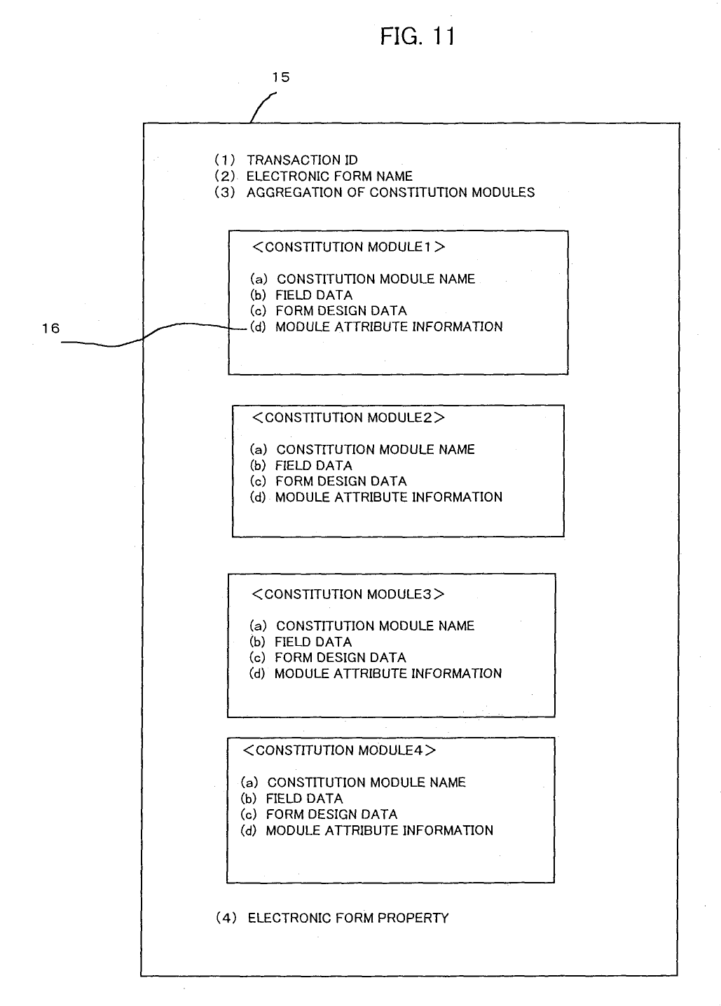

FIG. 11 conceptually shows the configuration of the electronic form 15 accumulated in a form library. The electronic form 15 according to the second embodiment includes four data of a transaction ID, an electronic form ID, an aggregation of constitution modules, and an electronic form property.

The “transaction ID” is the identification information of the transaction. Therefore, the same transaction ID is given to a plurality of electronic forms used in one transaction.

The “electronic form ID” is identification information of each electronic form. An ID is given to the contents of the electronic form. For example, different electronic form IDs are given to an “request for suspension of service to bank B”, an “request for suspension of service to mobile phone company E”, and the like, respectively.

The “constitution module” is a constituent element of the electronic form 15, and can be conceptually considered as one of a plurality of parts obtained by dividing one document data. For example, in a notification for changing a deduction bank account to a certain credit company, an input section of address/name, an input section of credit card number, and an input section of new account are formed. In the present invention, these input sections are constituted as different constitution modules, and one document of notification of changing a deduction bank account is formed as an aggregation of these constitution modules.

As shown in FIG. 11, each constitution module includes a constitution module name, field data, form design data, and module attribute information. The “constitution module name” is the title of the constitution module. In the above example, “Address/name”, “Changed account”, or the like is used. The “field data” is field data of each item constituting a constitution module. The “form design data” is display data for a rule, a frame, a hatched area, an item name, and the like which are used when these items are displayed on a display.

Concrete examples (except for the portion of the module attribute information) of constitution modules are the same as those shown in FIGS. 3A to 3E. When a user files request for suspension of service to bank B, bank C, credit company D, and mobile phone company E, respectively, the input section of address/name in the respective documents are identical to each other. Therefore, when the constitution modules of address/name are commonly used in the respective electronic forms, the user can save the trouble of inputting the address and the name to the respective documents.

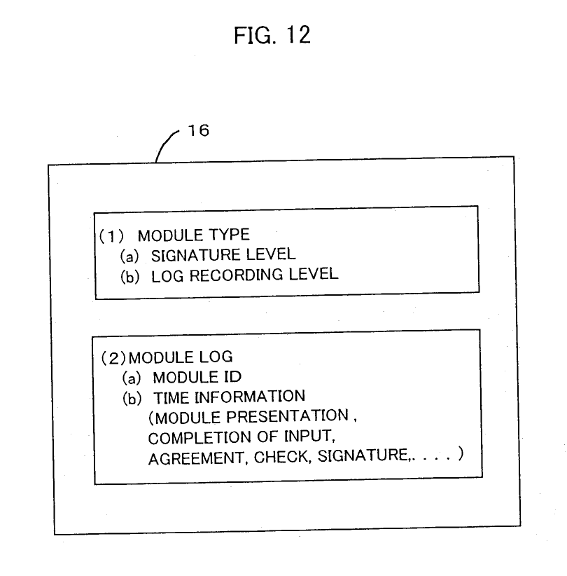

The “module attribute information” is information used in the processes performed in units of constitution modules. An example of the module attribution information is shown in FIG. 12. Module attribute information 16 includes a module type and a module log. The module type is information representing the type, the contents, the degree of importance, and the like of the constitution module. In this case, the information has a signature level and a log recording level. As will be described below, in the present invention, an electronic signature and a log recording process can be performed in units of constitution modules. The signature level is information for specifying the level of an electronic signature to be given to the constitution module, and the recording level is information for specifying a log recording level of the constitution module. The module log includes a module ID for specifying the constitution module and time information of processes executed in relation to the constitution module. The module attribute information will be described later.

The “electronic form property” is a field in which information of a route in which the electronic form flows in a workflow of a series of transactions, and is mainly used by the A-company server 3. The electronic form property may also include the ID of other electronic forms flown in the same transaction.

Next, the log recording in the present invention will be described below. In the present invention, the log recording is executed in two levels of a transaction unit and a constitution module unit. As described above with reference to FIG. 10B, the logs of processes executed in the transaction are recorded every event, and are stored in the transaction log file 22 shown in FIG. 10B.

In addition, log recording is performed in units of constitution modules. Log information of a constitution module unit is recorded as a “module log file” included in the module attribute information. The module log file basically includes a module ID for identifying the constitution module and time information. The time information can be recorded each time any process is performed to the constitution module. In general, one constitution module is transmitted from a service provider such as the A-company server to a user as a constituent element of an electronic form. The user inputs necessary matters to the constitution modules and appends an electronic signature to the constitution modules to return the constitution modules to the service provider. The service provider performs necessary checks. If the constitution modules have no problem, the service provider combines these constitution modules to create an electronic document. Therefore, times at which the processes in the series of processes may be recorded on a module log. More specifically, a time when a service provider shows the constitution module to a user, a time when the user complete the input operation, a time when the user appends an electronic signature, a time when the service provider server receives the input constitution module from the user, a time when the service provider completes the check of input items, and the like can be recorded as pieces of time information. In this manner, when log recording is performed every constitution module, not only the completion result of the transaction but also a detailed record in the process of creating an electronic document can be left.

As shown in FIGS. 10B and 12, the transaction log file 22 and the module log file include log recording levels. The “log recording level” is information which regulates a manner of taking a log depending on events included in the transaction, the types and the degrees of importance of the constitution modules, the contents of data input to the constitution modules by the user, a combination of a plurality of constitution modules, and the like. Referring to the transaction log, for example, if an event having a relatively high degree of importance and an event having a relatively low degree of importance are included in one transaction, detailed log recording can be performed for the event having a high degree of importance, and simple log recording, which records only a completion time, can be performed for the event having a low degree of importance. The log recording level in the transaction log file includes a log recording level of each event.

As a module log, with respect to a constitution module such as a module for address/name having a relatively low degree of importance, only a time when a service provider shows the constitution module to the user and a time when the input constitution module is received from the user may be recorded. With respect to a constitution module related to a certain contract having a high degree of importance, times of all processes are recorded. In this manner, the log recording levels can be controlled. A log recording level can also be changed depending on a combination of constitution modules. For example, a log recording level set when a single constitution module is used can be made different from a log recording level set when the constitution module is combined to another constitution module (both the constitution modules are included in one electronic form). In addition, the recording level can also be changed depending on the matter and data input to the constitution module. For example, in a constitution module including a description of an amount of money of a certain contract, when an input amount of money is large, a high log recording level can be set to save a detailed log. In this manner, log recording can be performed at an appropriate level depending on the characters, such as the types and the degrees of importance, of the constitution modules.

As another method, a log recording level can also be changed depending on selection by a user. In this case, a plurality of log recording levels (from a detailed log to a brief log) are prepared to cause the user to select a log recording level at the start of the transaction. Thus, log recording can be performed at a fineness level depending on a request of the user.

As described above, when log recording is performed while appropriately controlling a log recording level, in a demand for authentication in the future, verification, authentication and the like of detailed matters can be obtained in units of constitution modules. For example, in a transaction related to a contract with transfer of money, log recording is performed at a high log recording level, and a time when a contractor inputs necessary maters to an electronic document and a time when an electronic signature is appended can be accurately verified. Therefore, not only authentication of completion of a procedure (request for suspension of service to a bank or the like) performed in a transaction, but also verification of existence (e.g., the fact that a person A appended an electronic signature to a constitution module B at certain time on a certain date) of a process on each stage until the completion of procedure can be obtained. Therefore, if a problem occurs in the transaction later, detailed verification can be obtained.

Next, the electronic signature process in the present invention will be described below. The electronic signature process required in a transaction is managed in units of electronic documents and in units of constitution modules. A general application document has a blank for sign/seal. In many cases, one seal is set at one position of an entire document. This corresponds to an electronic signature in units of electronic documents. In addition, in the present invention, an electronic signature can be appended every constitution module.

The electronic signature is generally appended as follows. A signer processes target document data by a hash function, and encodes the result by a secret key of the signer. Data obtained by the encoding is transmitted as an electronic signature together with document data. The reception side holds a public key of the signer in advance and decodes the received electronic signature by the public key to obtain a process result by the hash function. At the same time, the received document data is processed by the same hash function to obtain a process result, and the process is compared with the process result obtained by decoding the electronic signature. When the process results are coincident with each other, it is confirmed that the document is transmitted by the signer.

As described above, various constitution modules are used, and the constitution modules are different from each other in type, degree of importance, and the like. Therefore, the levels of necessary electronic signatures are different from each other depending on the degrees of importance of the constitution modules. A signature level in module attribute information represents this level. For example, a constitution module such as a constitution module for address/name having a relatively low degree of importance can omit an electronic signature. Since a constitution module including a plan of insurance and an insurance amount in a contract document of an insurance or the like is considered as a constitution module having a high degree of importance, an electronic signature may be mandatory. In addition, a signature level can be regulated such that a combination of a plurality of constitution modules requires an electronic signature.

When electronic signatures can be appended in units of constitution modules, processes respectively performed by a plurality of persons, institutions and the like related to a transaction can be electronically signed in the sense of confirmation and verification. For example, the following case will be considered. That is, an electronic form provider provides several constitution modules to a user, and the user writes necessary matters and requests an agency to file an electronic document. In this case, when the user appends an electronic signature to a constitution module provided by the electronic form provider, it is verified that the constitution module is reliably handed to the user. When the user writes necessary matters, appends an electronic signature to the electronic document and files the electronic document to the agency, it is verified that the user makes a request to the agency. When the agency appends the electronic signature of the agency, files the electronic document to a related institution, and receives an electronic signature of the related institution, it is verified that the electronic document is filed to the related institution. Thus, if plural people or institutes involve one transaction, each of them can append its own electronic signature for the proof of their process. In this manner, when a problem occurs later, the record of the processes can be checked, and the cause of the problem and a locus of responsibility are made apparent.

When an electronic signature is mandatory, the type of the electronic signature can also be limited to a specific electronic signature depending on the contents of a constitution module. As has been described above, an electronic signature can be used only between a signer holding a secret key and a person or institution (an institution for issuing a signature or a certificate authority) holding the public key. Therefore, an electronic signature which is effective to only a specific institution can exist. For example, only a certain bank holds a public key, and an electronic signature formed by a corresponding secret key can be used for the bank. In this manner, since the electronic signature which is effective to only the specific institution exists, it can be made necessary that an electronic signature which is effective to only a certain institution is appended to a certain constitution module. For example, it can be made necessary that a constitution module constituting documents such as various notifications of changes or the like to a certain bank should be appended with an electronic signature which is effective to only that bank. In contrast to this, a notification for changing an address to be filed to a public office may be signed by a public electronic signature. This is similar to that a registered seal, a seal notified to a bank, an unofficial and unregistered personal seal, and the like can be distinctively used depending on the types and contents of conventional handwritten documents. In this manner, depending on a signature level in module attribute information, the necessity of a signature to the constitution module, and, if necessary, the type, the level, and the like of the signature can be regulated.

Since the electronic signature is made with encoding by a secret key, it can be considered that the security of a constitution module or electronic document data which is electrically signed is secured to some extent. However, besides the presence/absence of an electronic signature, the data itself of each constitution module may be encoded by various methods, and the encoded data may be transmitted and received on a network. In this manner, the security of the contents can be assured.

As an application of performing log recording and electronic signature every module, a service provider such as company A can insure or assure a transaction executed by a user. For example, when the user starts the transaction, the guidance of the assurance is shown to the user. When the user selects this, the service provider gives any assurance upon completion of the transaction. For example, when a problem will occur in a procedure included in the transaction at a later date, the service provider will bear the expense required to solve the problem. In addition, the contents of the assurance can be changed depending on the log recording level or the signature level which has been described above.

On the basis of the same concept as the use of an electronic signature, authentication obtained by a predetermined institution can also be used in place of an electronic signature. When a user registers an electronic signature in a certificate authority, the user receives a digital certification issued by the certificate authority and including a public key corresponding to a secret key. By using these keys, a hash value of target data is obtained to form an electronic signature. In this manner, it can be assured that the user herself/himself authenticated by the third party performs processes.

On the basis of the same consideration as described above, a user performs registration to a predetermined authentication institution in advance to acquire authentication information issued by the authentication institution. The user adds her/his authentication information in place of an electronic signature appended in units of electronic documents or constitution modules. A server such as the A-company server which receives data with the authentication information from the user inquires at the authentication institution by using the authentication information. In the authentication institution, the authentication information of a registered user is stored. When the A-company server designates the authentication information and inquires at the authentication institution, the authentication information is compared with the authentication information held in the authentication institution to perform authentication. When the two pieces of information coincide with each other, the authentication assures that the user who appended the authentication information is a registered user herself/himself. The A-company server trusts the user, and can continue the subsequent procedure. In this manner, when an authentication system managed by a specific authentication institution is used in place of an electronic signature, it can be assured that an identical person performs processes.

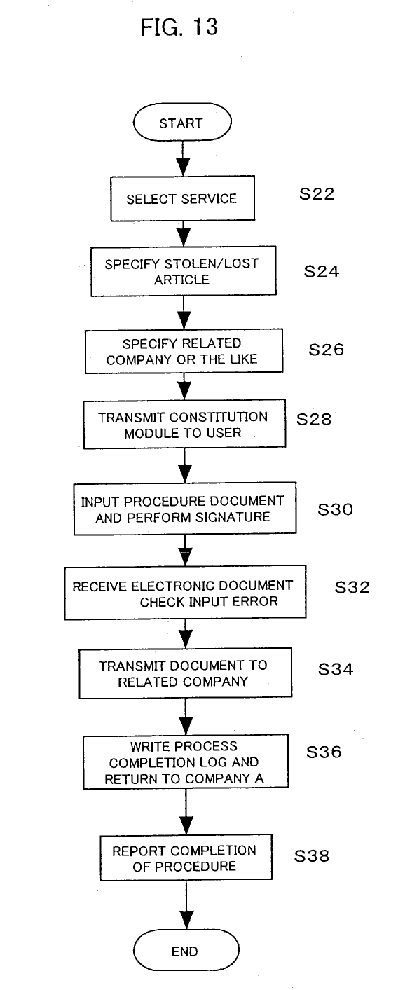

Next, an operation of an electronic document processing system according to the present invention will be described below. FIG. 13 is a flowchart showing electronic document processing according to the present invention. Screens of messages displayed on the client terminal 2 in the electronic document processing shown in FIG. 13 are the same as those shown in FIGS. 5 and 6. Documents created by the electronic document processing shown in FIG. 13 are shown in FIGS. 7A to 7C. In the following example, the following case will be exemplified. That is, a user P lost her/his bag and makes a request for suspension of service with the loss of the card of a bank account, a credit card and the like contained in the bag. More specifically, it is assumed that the user P lost the cards of accounts of bank B and bank C, a credit card of credit company D and a mobile phone of mobile phone company E.

Referring to FIGS. 13 and 5, the user P who lost her/his bag operates her/his client terminal 2 to access a website managed by the A-company server 3, so that a service screen (screen G50) is displayed. As shown in a screen G52, the user P selects a desired service (in this case, “3. THEFT/LOSS”) (step S22). With this selection, one transaction which is a theft/loss process is set to determine a transaction ID, so that a transaction file shown in FIG. 10A is prepared.

When the user P designates the desired service, as shown in a screen G54, the guidance of an ancillary service provided by company A is displayed. As shown in a screen G56, it is assumed that the user P selects both the services of “procedure process log management” and “document input error check”. The “procedure process management” is a service which records the transaction log and the module log which have been described above. When the user P receives this service, if any problem occurs later, the user P can receive authentication, notarization and the like of the completion of the procedure. On the other hand, the “document input error check” is a service which causes company A to check whether the maters input to the electronic form by the user P include an error or not.

As shown in a screen G58, a screen for designating a stolen/lost article appears, and the user P designates a lost article (step S24). In this example, as shown in a screen G60, the user P designates a “banknote/card”, a “credit card” and a “mobile phone”. As shown in a screen G62, a screen for designating a stolen/lost article appears. As shown in a screen G64, the user P designates related company of each stolen/lost article (step S26).

Upon completion of the designation of the related companies of the stolen/lost articles, the A-company server 3 shifts the process to the process of creating a notification document to be filed to each related company. More specifically, the A-company server 3 accesses the form library in the database 4 to acquire electronic form data of the specified notification document. By this, the transaction file 20 includes required electronic form data as shown in FIG. 10A.

Constitution modules included in the electronic form data of the plurality of acquired documents are extracted from the electronic form data and transmitted to the client terminal 2 in units of constitution modules (step S28). The contents of the transmitted constitution modules are displayed as shown in a screen G66 to enable the user P to input data. The screen G66 shows only module names of the constitution modules for illustrative convenience. However, in fact, as shown in FIG. 12, the contents of the constitution modules are displayed. The user P inputs necessary items in units of respective constitution modules (step S30). If necessary, an electronic signature is appended in units of modules. The necessity of an electronic signature for a constitution module, the level of a necessary electronic signature and the like are regulated by a signature level of the module attribute information 16. Therefore, the A-company server 3 requests the user to append an electronic signature having an appropriate level with reference to the signature level. The user P can also append an electronic signature to confirm that the input of the constitution module is reliably completed by him or her. In this manner, the electronic documents addressed to the related companies are completed, and the user P transmits these electronic documents to the A-company server 3 (screen G68).

The A-company server 3 receives the data input by the user P and checks an input error (step S32). Upon completion of the check of the input error, the A-company server 3 displays a confirmation screen as shown in a screen G70 to urge the user to check the confirmation screen. For illustrative convenience, the details of the confirmation screen are shown in FIG. 6. The user P performs confirmation, appends the electronic signatures to the electronic documents, and transmits the electronic documents to the A-company server 3 (screen G72). Thus, all the data of necessary electronic documents are collected in the transaction file 20 shown in FIG. 10A.

Then, as shown in FIG. 6, the A-company server 3 transmits the corresponding electronic form 15 and the corresponding transaction log file 22 to related companies (step S34, screen G74). For example, in the process for bank B in FIG. 6, the A-company server 3 transmits an application document addressed to bank B shown in FIG. 3B and the transaction log file 22 for event-1 shown in FIG. 10B to the B-bank terminal 10. The B-bank terminal 10 receives the request for suspension of service and executes a necessary suspension process. Time stamps at points of time in the suspension process, the transaction ID of the received request, and the IDs of bank B and an operator are recorded on the transaction log file 22 corresponding to the event. Information representing the completion of the suspension process (including an ID number of the process or the like) and the transaction log file 22 for which the log recording is completed are returned to the A-company server 3 (step S36, screen G76).

This process is performed for each related company. As a result, when the process is completed for all the related companies, the transaction log files 22 of all the events are collected. In FIG. 9, for illustrative convenience, procedures to the related companies are serially shown. However, in fact, transmission of electronic documents to a plurality of related companies, reception of a process completion report and the like can be handled in parallel to each other in terms of time.

In the above processes, the A-company server 3, the user, the related companies and the like records the logs of the processes performed by the A-company server 3, the user, the related companies and the like on the transaction log file 22 or the module log file. While a constitution module is exchanged between the A-company server 3 and the user, the logs of these processes are recorded on the module log files of the respective constitution modules. While an electronic document is exchanged between the A-company server and the related companies, the logs of the processes are recorded on the transaction log file 22 in units of events.

The A-company server 3 stores the transaction files 20 received from the related companies in the A-company server 3 or the database 4 such that the transaction files 20 are correlated with the transaction IDs. The A-company server 3 reports completion of the procedures to the user P together with data of a date when the procedure stop process is completed (step S38, screen G78). The user P watches the screen G78 to know that the procedures are safely completed. In addition, the A-company server 3 shows accounting information related to the services which have been performed to the user P (screen G80). In this case, on the screen G80, as inquiry information from the user, the transaction ID, the module IDs, other handle numbers and the like are displayed. In this manner, the transaction of a theft/loss notification of the user P is completed.

The user P can inquire about a process by using the transaction ID, the module ID and the like (G82). That is, the user P accesses the A-company server 3 by using the client terminal 2 and designates a transaction ID and a module ID, so that the user P can reads the transaction file 22 and the module log file corresponding to the transaction ID or the module ID. When the user P obtains the transaction log file 22 and the module log file as described above, the user P can records the transaction log file 22 and the module log file on her/his terminal or the IC card 5 after a security process such as an encoding process is performed. When the A-company server 3 manages the log files subjected to the security process, the A-company server 3 can authenticate the transaction as a whole.

The log information can be provided to a user by various methods other than a method of recording log information on the IC card 5. For example, a log file transmitted to the client terminal 2 can be printed on a medium such as a sheet of paper.

When a user does not request log information, the log information or information related thereto can be provided to the user. For example, it can be considered that important document data such as contract document data and confirmation document data are created upon completion of a certain procedure, and a user prints the important document data on paper media and stores the paper media. For example, the important document data are an insurance policy in an insurance contract, a contract document in a loan contract, and the like. In this case, although document data is transmitted from the A-company server to a client terminal, a log file can be added to the document data itself. By this, a user obtains document data of a contract document or the like, and can simultaneously acquire log data of procedures performed until the contract is established. In addition, the log file added to the document data may be invisible data, so that the log file can be read only when special reading software or the like is used. Furthermore, a log file itself is not added, and, for example, information such as an ID, a bar code, a management number or the like, related to the log file, for specifying the log file can be added to the document data to be provided to the client terminal. In this case, when a user prints the document data to create a paper document such as a contract document, log data or data related to the log data can also be visibly or invisibly printed at a part of the document.

When a user prints data required for a procedure on a paper document, a date and a time at which the print is performed, a person who performs the print, the number of times of the print and other information can also be transmitted as print log data to the A-company server. Thus, when an important document such as a contract document is printed on paper media on the user side, the record of the print can be stored on the A-company server side. In this case, when the person who performs the print is a person who is authenticated by using the authentication system described above, it can be recorded whether the print is performed by the person. Thus, an illegal print performed by the third party can be detected.

In the above example, the user can select whether a recording service of a procedure log is requested or not in selection of a service (see screen G54 in FIG. 5). Instead of this, it can also be determined, on the basis of an amount of money related to the transaction or the degree of importance of the transaction, whether the procedure log is stored or not.

When the log recording is used, a user can interrupt one transaction on the way and restart the transaction from the interruption point. For example, the A-company server 3 shows a process performed until the user interrupts the process on the way and notifies the user of the transaction ID of the process. The user designates the transaction ID when the process is restarted. The A-company server can restart the transaction halfway with reference to a transaction log and a module log included in the transaction file. In addition, even if the user interrupts an electronic document creating process performed in units of constitution modules, since the module logs are recorded in units of constitution modules, the A-company server knows the degree of progress of the processes at the present with reference to the module logs, and the A-company server can navigate the user to the next process.

Under present circumstances, upon completion of filing of electronic documents from the A-company server to related companies, several days may be required to complete processes in the related companies. In such a case, the A-company server notifies a user of a transaction ID, and notifies the user of an expected date of completion of processes in a related company. The user accesses the A-company server again upon completion of the processes in the related company and designates the transaction ID, so that the user can know the degree of progress of the processes. The interrupt/restart processes as described above can be realized by log recording for a transaction.

In the above example, an electronic form designated by a user is transmitted to a client terminal, and the user outputs the electronic form onto a sheet of paper by using a printer, so that a paper document or the like can be created. In this case, when electronic filing of document has not been permitted, and when the paper size of the document is limited to a specific size by a destination side, a user can output an electronic form onto a sheet of paper by using a printer terminal installed in a convenience store or the like.

Instead of outputting an electronic form onto a sheet of paper by a user herself/himself, an output of an electronic form onto a sheet of paper, delivery to a user, and filing can also be carried out by another agency. In this case, the A-company server provides an electronic form designated by a user to the agency via a network or the like, and the agency outputs the electronic form onto a predetermined sheet of paper to create a document, and delivers the document to the user. The agency may collect the executed documents on which predetermined matters are written by a user and files the document to a corresponding destination, so that the agency can carry out the application for the user. When the agency always reports a degree of progress of a series of operations to the A-company server, the degree of progress of the procedure can be managed as logs on the A-company server side.

When a user or each related institution appends an electronic signature to a constitution module or an electronic form, a secret key may be held by not only a terminal device such as the client terminal 2 or the A-company server but also an external storage medium such as the IC card 5. When a signature subject such as a user or a related company causes the third party institution to manage a secret key, an electronic signature may be appended via the institution.

It is noted that the above application contents, the related companies and the like are only examples. The present invention can be applied to a case in which documents are filed or handed to various related companies, public offices, people and the like in various situations such as a house-moving and a marriage.

As described above, according to the electronic document processing system according to the second embodiment, a user communicates with a service provider via a network. The user easily acquires the form of a document required for a desired notification/application or the like, and the user can rapidly file the document to related institutions. In addition, since the service provider manages log recording of a series of processes, when confirmation or verification is required later, the user need not inquire at the respective related institutions. The user can read the records of all the processes at once, and can obtain authentication or the like.

In addition, since log recording is performed at an appropriate log recording level for each constitution module constituting an electronic document, the utility value of the records increases. Furthermore, since an electronic signature can be appended to each constitution module, a series of processes can be safely and reliably performed.

### INDUSTRIAL APPLICABILITY

As has been described above, an electronic document processing method and apparatus according to the present invention is useful to construct a system which creates an electronic document by acquiring an electronic form via various networks including the Internet and performs the procedures of an application, a notification and the like to government and other public offices, enterprises, and the like online.

1. An electronic document processing apparatus connected to a user terminal via a network, comprising:
a database in which an electronic form constituted as an aggregation of a plurality of constitution modules, each corresponding to a part of one document, is accumulated;
an electronic form acquiring device for acquiring an electronic form required for a transaction designated by a user from the database as the aggregation of constitution modules;
a presenting device for presenting the acquired constitution module to the user to request the user to input predetermined information; and
an electronic document creating device for combining the constitution modules, to which the user completed information input, to create an electronic document of the necessary document.

2. An electronic document processing apparatus according to claim 1, wherein the presenting device presents a constitution module which is commonly included in a plurality of electronic forms only once.

3. An electronic document processing apparatus according to claim 1, further comprising a correction request device for receiving a constitution module to which the user completed information input, for checking the input information depending on a predetermined check process method, and, if the input item has an error, for showing that the input information has an error to the user to request the user to correct the error.

4. An electronic document processing apparatus according to claim 1, further comprising:
a document filing device for transmitting a created document to a destination terminal device via the network; and
a report device for receiving a notification of completion of filing the document from the destination terminal device and making a report of completion of filing to the user.

5. An electronic document processing apparatus according to claim 4, further comprising a time information recording device for recording information of a time when the document filing device transmits a document to a destination terminal and recording information of a time when the user receives the notification of completion of filing from the destination terminal device.

6. An electronic document processing apparatus according to claim 5, wherein the report device reports the time information recorded by the recording device such that the time information is included in the report of completion of filing.

7. An electronic document processing apparatus according to claim 3, wherein each of the constitution modules includes check information, and wherein the correction request device makes a correction request with reference to the check information.

8. An electronic document processing apparatus according to claim 7, wherein the check information represents a type of a constitution module including the check information therein and a degree of importance of information input to the constitution module, and wherein the correction request device checks whether a correction request is made depending on the degree of importance and determines the degree of correction request.

9. An electronic document processing apparatus according to claim 1, further comprising a constitution module creating device for acquiring a constitution module designated from the database depending on an operation of an operator and changes the constitution module to create a new constitution module.

10. An electronic document processing apparatus according to claim 1, wherein the constitution module includes display specifying information for specifying display information related to the constitution module, and wherein the presenting device presents the constitution module and the display information related to the constitution module to the user with reference to the display specifying information.

11. An electronic document processing apparatus according to claim 1, further comprising an automatic input/output device for acquiring information to be input to the constitution module presented by the presenting device from an external storage medium to automatically input/output the information to the constitution module.

12. An electronic document processing method using an electronic document processing apparatus connected to a user terminal via a network and having a database in which an electronic form constituted as an aggregation of a plurality of constitution modules each corresponding to a part of one document is accumulated, comprising:
the process of acquiring an electronic form required for a transaction designated by a user from the database as the aggregation of constitution modules;
the process of presenting the acquired constitution module to the user to request the user to input a predetermined item; and
the process of combining the constitution modules to which the user input information to create an electronic document of the necessary document.

13. An electronic document processing apparatus connected to a user terminal and a related institution terminal via a network, comprising:
a constitution module acquiring device for acquiring a constitution module constituting an electronic form of a document required for a transaction designated by a user;
an electronic document creating device for transmitting the constitution module to the user via the network and receiving a constitution module subjected to a creating process by the user to create an electronic document as an aggregation of constitution modules;
a module log recording device for recording and storing a module log serving as log information of processes performed by the user and the electronic document creating device in creation of an electronic document by transmission/reception of the constitution module with the user.

14. An electronic document processing apparatus according to claim 13, wherein the module log recording device records and stores the log information as attribute data of constitution modules in units of constitution modules.

15. An electronic document processing apparatus according to claim 14, wherein the module log recording device records log information at fineness levels on the basis of at least one of a type or a degree of importance of a constitution module, contents input to the constitution module and a combination of a plurality of constitution modules.

16. An electronic document processing apparatus according to claim 13, wherein the electronic document creating device appends a necessary electronic signature to each constitution module and requests the user to append the necessary electronic signature to each constitution module.

17. An electronic document processing apparatus according to claim 16, wherein the electronic document creating device determines the necessity of a request of an electronic signature to a user and a type of the electronic signature to be requested on the basis of at least one of a type or a degree of importance of a constitution module, contents input to the constitution module and a combination of a plurality of constitution modules.

18. An electronic document processing apparatus according to claim 13, further comprising:
a transmission device for transmitting an electronic document created by the electronic document creating device to a related institution terminal via the network; and
a transaction recording device for receiving log information of processes performed in the related institution and recording the log information as a transaction log such that the log information is correlated with the transaction.

19. An electronic document processing apparatus according to claim 18, further comprising:
a reception device for receiving a demand for reading the log information from the user; and
a log information providing device for acquiring a transaction log corresponding to a transaction designated by the demand for reading to provide the transaction log to the user.

20. An electronic document processing apparatus according to claim 19, wherein the log information providing device acquires the module log when the demand for reading includes designation of a constitution module, and provides the module log to the user.

21. An electronic document processing apparatus according to claim 18, further comprising:
a reception device for receiving a demand for verifying the log information from the user;
a verification device for acquiring a designated transaction log or a designated module log when the demand for verification is received, and performing verification related to the acquired log.

22. An electronic document processing apparatus according to claim 13, further comprising a degree-of-progress notification device for referring to a transaction log corresponding to a designated transaction and a module log related to the transaction when a degree of progress is inquired by the user, for acquiring the degree of progress of the transaction, and for notifying the user of the degree of progress.

23. An electronic document processing apparatus according to claim 13, further comprising a log output device for outputting the log information to a recording medium of the user.

24. An electronic document processing method executed by an electronic document processing apparatus connected to a user terminal and a related institution terminal via a network, comprising:
the process of acquiring a constitution module constituting an electronic form of a document required for a transaction designated by a user;
the process of transmitting the constitution module to the user via the network and receiving a constitution module subjected to a creating process by the user to create the electronic document as an aggregate of constitution modules; and
the process of recording and storing log information of processes performed by the user and the electronic document processing apparatus in creation of an electronic document by transmission/reception of the constitution module with the user.
